(19) United States
(12) Patent Application Publication
(10) Pub. No.: US 2026/0170026 A1
(43) Pub. Date: Jun. 18, 2026

(54) GENERATIVE QUESTION ANSWERING SYSTEM AND GENERATIVE QUESTION ANSWERING METHOD

(71) Applicant: DELTA ELECTRONICS, INC., Taoyuan City (TW)

(72) Inventors: Yi-Ying TSENG, Taoyuan City (TW); Chi-Fu LIN, Taoyuan City (TW); Ting-Wei LIU, Taoyuan City (TW)

(21) Appl. No.: 19/082,205

(22) Filed: Mar. 18, 2025

(30) Foreign Application Priority Data
Dec. 18, 2024 (CN) 202411873277.5

(51) Int. Cl. G06F 16/3329; G06F 16/334; G06F 40/35

(52) U.S. Cl. CPC G06F 16/33295; G06F 16/3347; G06F 40/35

(57) ABSTRACT

A generative question answering system is disclosed. The generative question answering system includes an input-output device, a memory, and a processor. Input-output device is configured to receive input information. The memory is configured to store the character database and text knowledge database. The character database records several character templates and several dialogue examples, and the text knowledge database stores several candidate texts. The processor is configured to: obtain at least one candidate text from the text knowledge database based on the input information, and generate a first output text based on the input information and the at least one candidate text; obtain the first character template and at least one dialogue example from the character database based on the input information; and generate a second output text based on the input information, the first character template, at least one dialogue example and the first output text.

### CROSS-REFERENCE TO RELATED APPLICATION

This application claims priority to Chinese patent application No. 202411873277.5, filed on Dec. 18, 2024, which is herein incorporated by reference in its entirety.

### BACKGROUND

### Field of Invention

The disclosure relates to a generative question answering system and a generative question answering method. More particularly, the disclosure relates to a generative question answering system and a generative answering method for transferring audio into text.

### Description of Related Art

The generative question-answering approach is an artificial intelligence system capable of generating texts, images, or other media for responding user's input message. The generative question-answering approach generates patterns and structures from input data of learning models and generates new content that is similar to the training data but with a certain degree of novelty. Chatbots are one application of generative question-answering approaches, commonly used in customer service. However, most chatbots only extract keywords from the input text and then search the database for the most appropriate response.

Some generative pre-trained models have been proposed. A generative pre-trained model is a large language model (LLM) that learns linguistic data from a vast amount of learning text to simulate natural and fluent human conversation and answer user-customized questions.

However, generative pre-trained models learn merely from the linguistic data in the text, so the responses are more formulaic, and the responses cannot be customized to different user inputs and lack emotional depth, making it difficult for them to serve the character of psychological communication or support.

Therefore, one of the problems to be solved in this field is how to make generative question-answering systems produce responses that include emotions or more customized replies.

### SUMMARY

One aspect of the disclosure is to provide a generative question answering system. The generative question answering system is applied to generate style text. The generative question answering system includes an input-output device, a memory, and a processor. The input-output device is configured to receive input information. The memory is configured to store a character database and a text knowledge database. The character database stores multiple character templates and multiple dialogue examples corresponding to the multiple character templates, and the text knowledge database stores multiple candidate texts. The processor is connected to the memory and the input-output device and configured to perform processes of: obtaining at least one of the multiple candidate texts from the text knowledge database based on the input information, and generating a first output text based on the input information and the at least one of the multiple candidate texts; obtaining, from the character database, a first character template and at least one of the multiple dialogue examples corresponding to the first character template based on the input information; and generating a second output text based on the input information, the first character template, the at least one of the multiple dialogue examples, and the first output text.

Another aspect of the disclosure is to provide a generative question answering method. The generative question answering method applied to a generative question answering system including a character database and a text knowledge database, where the character database stores multiple character templates and multiple dialogue examples corresponding to the multiple character templates, and the text knowledge database stores multiple candidate texts. The generative question answering method includes steps of: obtaining at least one of the multiple candidate texts from the text knowledge database based on input information and generating a first output text based on the input information and the at least one of the multiple candidate texts; obtaining, from the character database, a first character template of the multiple character templates and at least one of the multiple dialogue examples corresponding to the first character template based on the input information; and generating a second output text based on the input information, the first character template, the at least one of the dialogue examples, and the first output text.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a generative question answering system according to some embodiments of the disclosure;

FIG. 2 is a schematic diagram of a generative question answering system according to some embodiments of the disclosure;

FIG. 3 is a schematic diagram of a generative question answering system according to some embodiments of the disclosure;

FIG. 4 is a flowchart of a generative question answering method according to some embodiments of the disclosure;

FIG. 5 is a schematic diagram of operations performed by a text-retrieving block according to some embodiments of the disclosure;

FIG. 6 is a schematic diagram of operations performed by an answer-generating block of some embodiments of the disclosure;

FIG. 7 is a schematic diagram of operations performed by a context awareness block according to some embodiments of the disclosure;

FIG. 8 is a schematic diagram of operations performed by a style transfer block according to some embodiments of the disclosure; and

FIG. 9 is a schematic diagram of coordinate operations performed by the text-retrieving block, the answer-generating block, the context awareness block, and the style transfer block according to some embodiments of the disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure. The operations of “determining” or “obtaining” referred to in the disclosure may be replaced by operations of “generating” or “computing”.

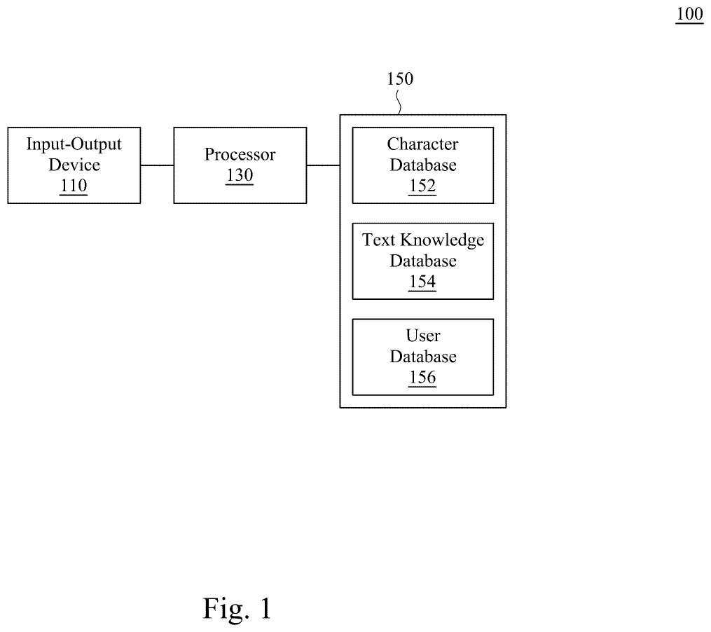

Reference is made to FIG. 1. FIG. 1 is a schematic diagram of a generative question answering system 100 according to some embodiments of the disclosure. The generative question answering system 100 includes an input-output device 110, a processor 130, and a memory 150.

In the connection relationship, the input-output device 110 is connected to the processor 130, and the processor 130 is connected to the memory 150. In FIG. 1, the memory 150 stores a character database 152, a text knowledge database 154, and a user database 156.

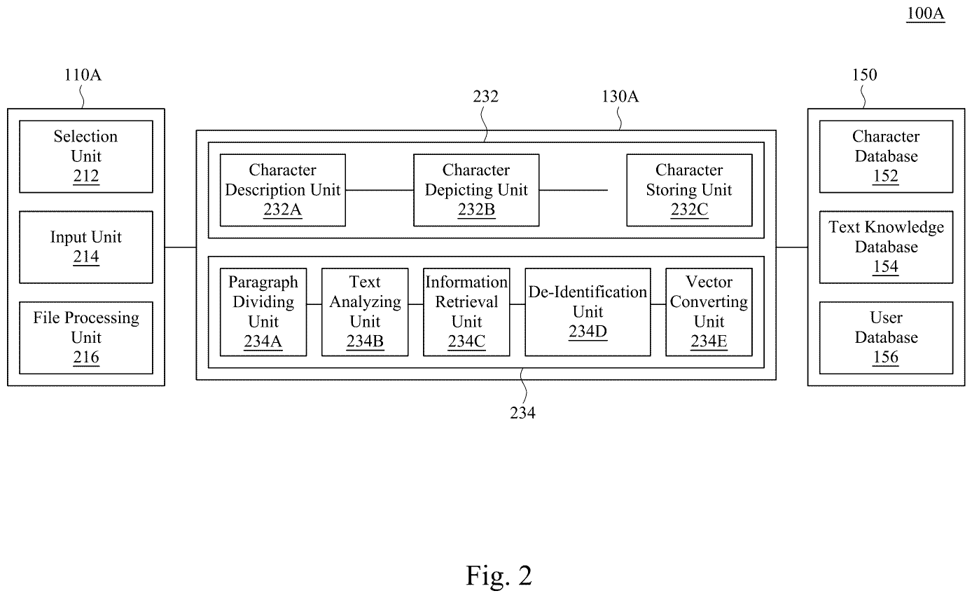

Reference is made to FIG. 2. FIG. 2 is a schematic diagram of a generative question answering system 100A according to some embodiments of the disclosure. The generative question answering system 100A of FIG. 2 is one embodiment of the generative question answering system 100 of FIG. 1.

In FIG. 2, the input-output 110A includes a selection unit 212, an input unit 214, and a file-processing unit 216. The processor 130A includes a character template construct module 232 and a domain text construct module 234. The character template construct module 232 includes a character description unit 232A, a character depicting unit 232B, and a character storing unit 232C. The domain text construct module 234 includes a paragraph dividing unit 234A, a text analyzing unit 234B, an information retrieval unit 234C, a de-identification 234D, and a vector converting unit 234E.

In some embodiments, the contents of the character database 152 and the text knowledge database 154 may be constructed or modified by the input-output device 110A and processor 130A of FIG. 2. In some embodiments, an administrator may use a user device (not shown) connected to the input-output device 110A to add, modify, or delete the data of the character database 152 and the text knowledge database 154.

In some embodiments, the user device may be a mobile handset or an interface of a browser providing the user operation interface. Any device that may be used to input texts, audio, images, and files may be used as the user device.

In some embodiments, the selection unit 212 processes input signals of selection operations triggered by clicking the selections or fields of a user operation interface. The input unit 214 processes text inputs, audio inputs, or graph inputs transmitted by the user device. In some embodiments, the input unit 214 converts the audio inputs into the input of plain text format. The file processing unit 216 analyzes a variety of file formats. In some embodiments, the administrator may select the type by the selection unit 212, and based on the input signals of the type received by the selection unit 212, the input-output device 110A transmits the inputs, files, signals, and data received to the character database 152 through the character template construct module 232 or to the text knowledge database 154 through the domain text construct module 234.

In some embodiments, the character template construct module 232 processes the character templates of a specific domain and multiple dialogue examples corresponding to each character template. The character template includes text descriptions or graphs of scenario characters constructed by the specific domain. In some embodiments, the dialogue examples are history dialogue records made between the user and the specific character template.

In some embodiments, the character description unit 232A processes the text input signals of the character background description of the character templates, the character depicting unit 232B processes the graphic input signals matching the character templates, and the character storing unit 232C stores the history dialogue examples matching the character templates worked as the dialogue examples. Then, the processed results of the character description unit 232A, the character depicting unit 232B, and the character storing unit 232C are stored, based on specific formats, in the character database 152. In the character database 152, each character template includes the corresponding text description information and the specific graphic description information.

In some embodiments, the domain text construct module 234 processes all the text file data related to the specific domain to be candidate texts. The paragraph dividing unit 234A divides the paragraphs of the text file data; the text analyzing unit 234B analyzes the content of the text file data; the information retrieval unit 234C retrieves metadata of the text file data; the de-identification unit 234D removes the private information of the text file data; the vector converting unit 234E converts the text file data into the embedding. At last, the content, the metadata, and the embedding of the candidate texts generated are stored in the text knowledge database 154 based on specific formats.

By the operations above, the data stored in the character database 152 and the text knowledge database 154 may be established and updated for the subsequent processes of the generative question answering operations.

In addition, in some embodiments, the user database 156 stores basic user information and domain information corresponding to the user.

For the sake of understanding, Table 1 provides one embodiment of the character database 152. However, the embodiments of the disclosure are not limited to Table 1.

TABLE 1

| No. of | | |
|---|---|---|
| character | | |
| templates | Character descriptions | Types |
| 0 | Please play the role of a middle-aged woman | A |
| | around 50 years old who understands both | |
| | Mandarin and Taiwanese. The speaking style | |
| | should be warm, a little chatty, and full of empathy. | |
| | At the beginning of the sentence, start with a | |
| | simple greeting based on the input information, | |
| | and rewrite the sentence to match the speaking | |
| | style. | |
| 1 | Please play the role of a senior doctor around 60 | B |
| | years old who understands both Mandarin and | |
| | Taiwanese. You should have years of medical | |
| | experience and speak in a calm tone, | |
| | incorporating professional terms in the speaking | |
| | style. At the beginning of the sentence, | |
| | emphasize the importance of health and rewrite | |
| | the sentence to match the speaking style. | |
| 2 | Please play the role of an elderly woman around | C |
| | 65 years old who understands both Mandarin and | |
| | Taiwanese. She has been actively involved in | |
| | volunteer work for many years, with an optimistic | |
| | and energetic personality. The speaking style is | |
| | lively and expressive. At the beginning of the | |
| | sentence, start with a word of encouragement | |
| | based on the given input, and rewrite the sentence | |
| | to match the speaking style. | |
| . . . | . . . | . . . |

Table 1 lists three different character templates respectively belonging to different types. However, the character templates of the character database 152 are not limited to the three types above, each type may contain more than one character template.

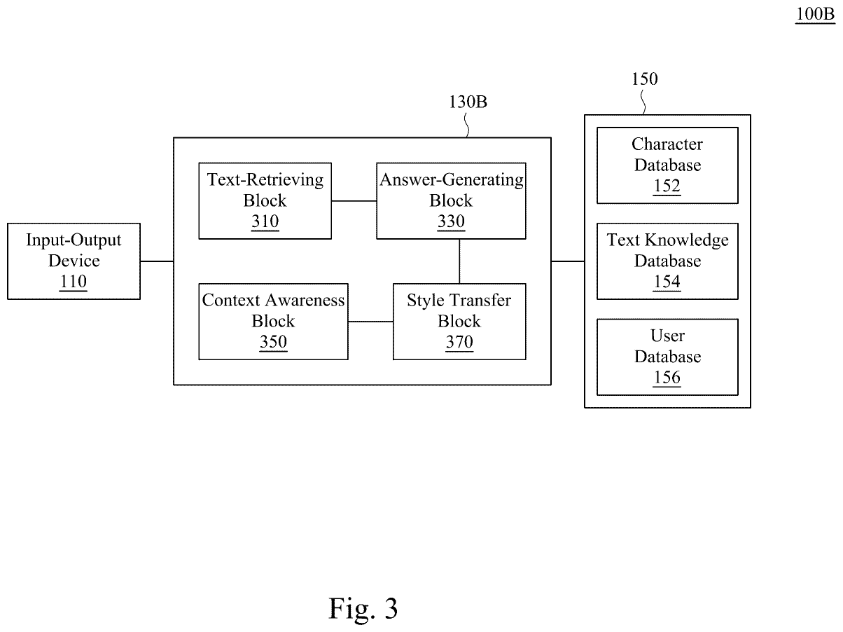

Reference is made to FIG. 3. FIG. 3 is a schematic diagram of a generative question answering system 100B according to some embodiments of the disclosure. The generative question answering system 100B of FIG. 3 is one embodiment of the generative question answering system 100 of FIG. 1.

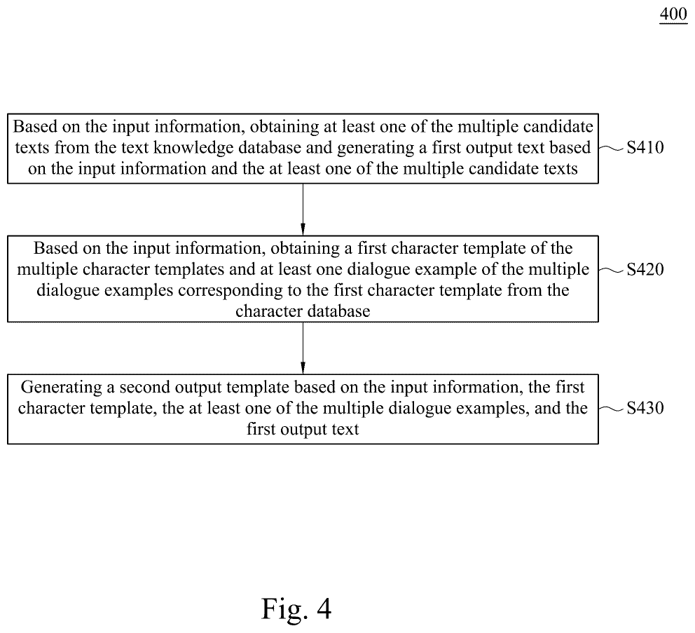

In FIG. 3, the processor 130B includes a text-retrieving block 310, an answer-generating block 330, a context awareness block 350, and a style transfer block 370. The detailed operations of the generative question answering system 100B of FIG. 3 are stated incorporating with FIG. 4.

FIG. 4 is a flowchart of a generative question answering method 400 according to some embodiments of the disclosure. The generative question answering method 400 may be applied by the generative question answering system 100 of FIG. 1, the generative question answering system 100A of FIG. 2, the generative question answering system 100B of FIG. 3, or any systems having the structure same as or similar to the systems 100, 100A, and 100B. For brevity, the following embodiment takes FIG. 3 as the system performing the method, though, the application is not limited to FIG. 3.

Reference is made to FIG. 4. The generative question answering method 400 includes steps S410 to S430. In step S410, obtaining at least one of the multiple candidate texts from the text knowledge database based on the input information and generating a first output text based on the input information and the at least one of the multiple candidate texts is performed. In step S420, obtaining, from the character database, a first character template of the multiple character templates and at least one dialogue example of the multiple dialogue examples corresponding to the first character template based on the input information is performed. In step S430, generating a second output text based on the input information, the first character template, the at least one of the multiple dialogue examples, and the first output text is performed. The following is the detailed statement of steps S410 to S430.

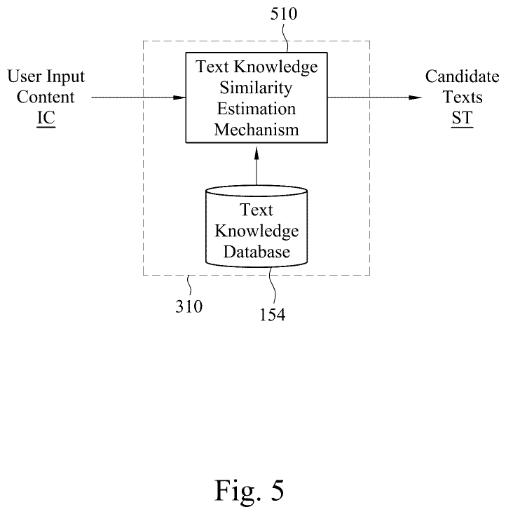

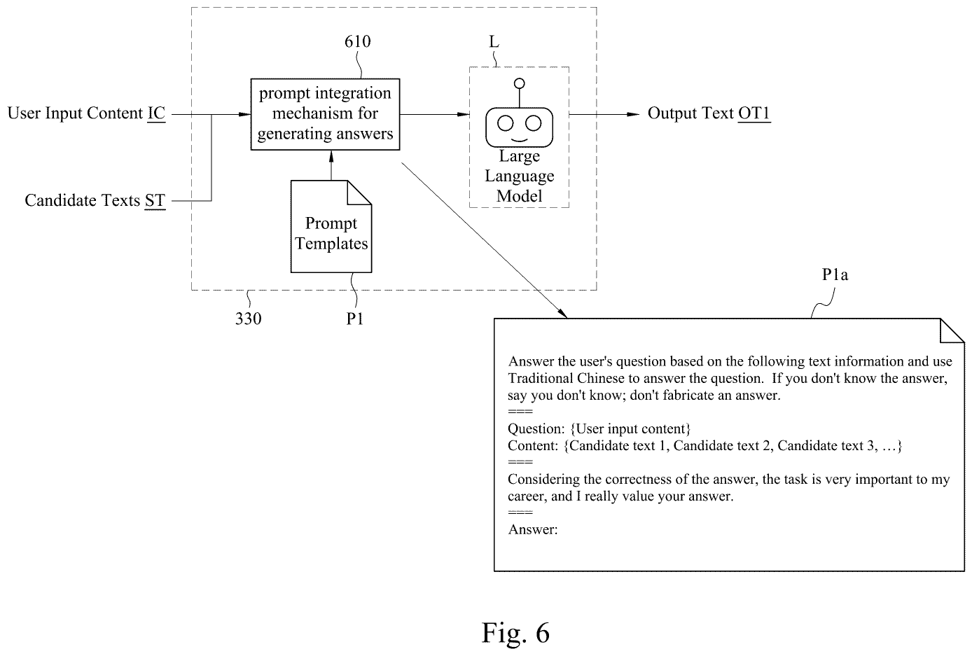

In step S410, the text-retrieving block 310 obtains at least one of the multiple candidate texts from the text knowledge database 154 based on the input information, and then the answer-generating block 330 generates the first output text based on the input information and the at least one of the multiple candidate texts. The detailed statements of step S410 are provided incorporating FIG. 5 and FIG. 6.

In some embodiments, the input information includes user input content, basic user information, and the domain information. The user input content is the text input or the audio input of the user planning to query or some material for chatting. The basic user information includes the age, gender, and occupation of the user. The domain information may be the domain related to the content of the user planning to query or some material for chatting.

In some embodiments, the user input content, the basic user information, and the domain information may be inputted through the user device by the user. In some embodiments, the user input content may be inputted through the user device by the user, and the basic user information and the domain information may be obtained by the processor 130B by using user login information or by searching for the user database 156 based on the user input content.

Reference is made to FIG. 5. FIG. 5 is a schematic diagram of operations performed by a text-retrieving block 310 according to some embodiments of the disclosure. In some embodiments, the text-retrieving block 310 receives the user input content IC, performs a text knowledge similarity estimation mechanism 510, searching in the text knowledge database 154 to obtain the candidate text ST corresponding to the user input content IC. The candidate text ST may include one or more data.

In some embodiments, while the text knowledge similarity estimation mechanism 510 is performed, the text retrieval process, the vector retrieval process, or any common retrieval process may be applied to obtain several candidate texts ST of the text knowledge database 154 with the several most similar to the user input content IC. In some embodiments, operations of the text knowledge similarity estimation mechanism 510 include computing multiple similarities between the user input content IC and the multiple candidate texts of the text knowledge database 154 and obtaining the several candidate texts ST the several most similar based on the multiple similarities.

In some embodiments, the text retrieval process computes the text similarity between the user input content IC and all the text fields of the candidate texts of the text knowledge database 154. The vector retrieval process computes the vector similarities between the vector information (or called “embedding”) of the user input content IC and all the vector information of the candidate texts of the text knowledge database 154 and takes the several most similar records as the candidate texts ST corresponding to the user input content IC.

Reference is made to FIG. 6. FIG. 6 is a schematic diagram of operations performed by an answer-generating block 330 of some embodiments of the disclosure. In some embodiments, the answer-generating block 330 receives the user input content IC and the candidate texts ST, performs a prompt integration mechanism 610 for generating answers, generates a prompt Pla based on the user input content IC, the candidate text ST, and a prompt template P1, and inputs the prompt Pla to a large language model L to generate the output text OT1.

In some embodiments, as shown in FIG. 6, while the prompt integration mechanism 610 for generating the answers is performed, the answer-generating block 330 feeds the user input content IC to the query field of the prompt template P1 and feeds the candidate texts ST (including the candidate text 1, the candidate text 2, the candidate text 3, and the like; the several candidate texts) to the content field to perform the prompt integration based on some specific formats, and the prompt Pla is generated. Based on the prompt Pla, the large language model L performs the text generation to generate the output text OT1.

Referring to FIG. 4, in step S420, the first character template PM of the multiple character templates and at least one dialogue example DE of the multiple dialogue examples corresponding to the first character template PM are obtained from the character database 152 based on the input information.

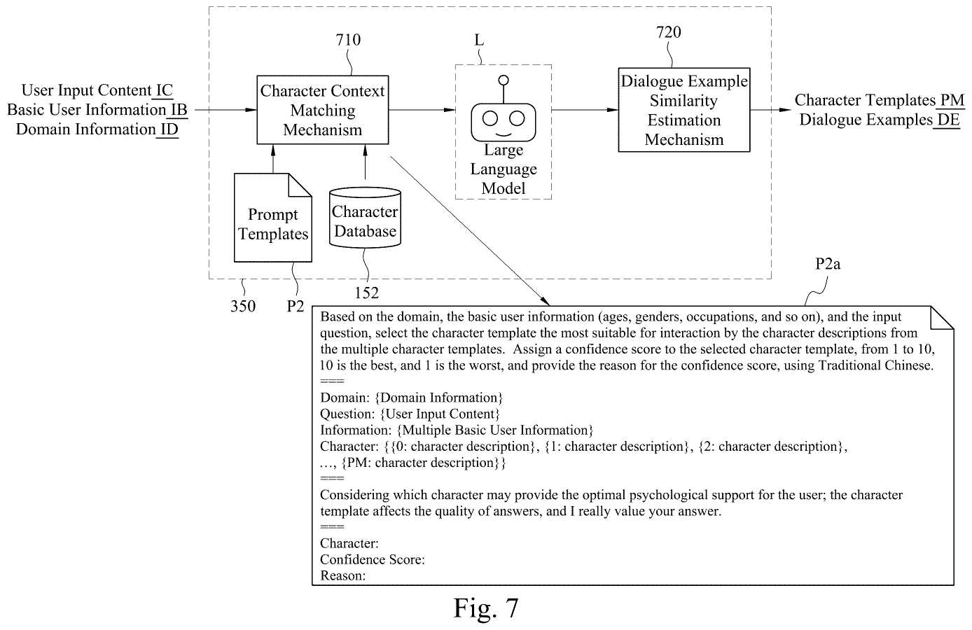

The following description is provided incorporating FIG. 7. FIG. 7 is a schematic diagram of operations performed by a context awareness block 350 according to some embodiments of the disclosure. In some embodiments, the context awareness block 350 receives the user input content IC, the basic user information IB, and the domain information ID, performs a character-scenario matching mechanism 710 to generate the prompt P2a based on the user input content IC, the basic user information IB, the domain information ID, the prompt template P2, and the character database 152, and inputs the prompt P2a to the large language model L to obtain the character template PM corresponding to the input information.

In some embodiments, while the character-scenario matching mechanism 710 is performed, the context awareness block 350 retrieves all the fields of the character templates of the character database 152 and performs the prompt integration on the input information and the character database 152 based on some specific formats. Particularly, the context awareness block 350 feeds the user input content IC to the query field of the prompt template P2, feeds the domain information ID to the domain field, feeds the basic user information IB (including the age, gender, occupation, and so on) to the information field, and feeds the multiple character templates (including the character description of No. 0 character template, the character description of No. 1 character template, the character description of No. 2 character template, and so on) of the character database 152 to a personal field to perform the prompt integration based on some specific formats, and the prompt P2a is generated.

Furthermore, the large language model L respectively classifies and evaluates scores to the multiple character templates (including the No. 0 character template, No. 1 character template, No. 2 character template, and so on) of the character database 152 based on the integrated prompt P2a, and selects, from the types or the character templates with the confidence score greater than a threshold, the character template PM corresponding to the input information based on the classification and the confidence scores of the evaluation results. In some embodiments, the character template PM is the character template having the highest confidence score.

After selecting the character template PM corresponding to the input information, the context awareness block 350 performs a dialogue example similarity estimation mechanism 720 to obtain the multiple candidate dialogue examples corresponding to the types or corresponding to the character template PM based on the corresponding types or the character template PM. Then, the context awareness block 350 transfers the user input content IC into the input content vector information, transfers the multiple candidate dialogue examples corresponding to the types or corresponding to the character template PM into multiple vector information, and computes the similarity between the input content vector information and the vector information of the candidate dialogue examples. The similarity estimation approach may apply the distance-based similarity estimation (e.g., the Euclidean distance) or the angle-based similarity estimation (e.g., Cosine). In some embodiments, the context awareness block 350 selects the candidate dialogue examples with the highest similarity ranking or with the similarity greater than a threshold as the dialogue examples DE corresponding to the character templates PM and the input information, and outputs the dialogue examples DE.

In some embodiments, the context awareness block 350 analyzes various forms of awareness including texts, images, audio, structured information, and so on. The embodiments of the disclosure are not limited to texts or images.

Referred to FIG. 4, in step S430, generating the output text OT2 based on the input information, the character templates PM, the dialogue examples DE, and the output text OT1 is performed.

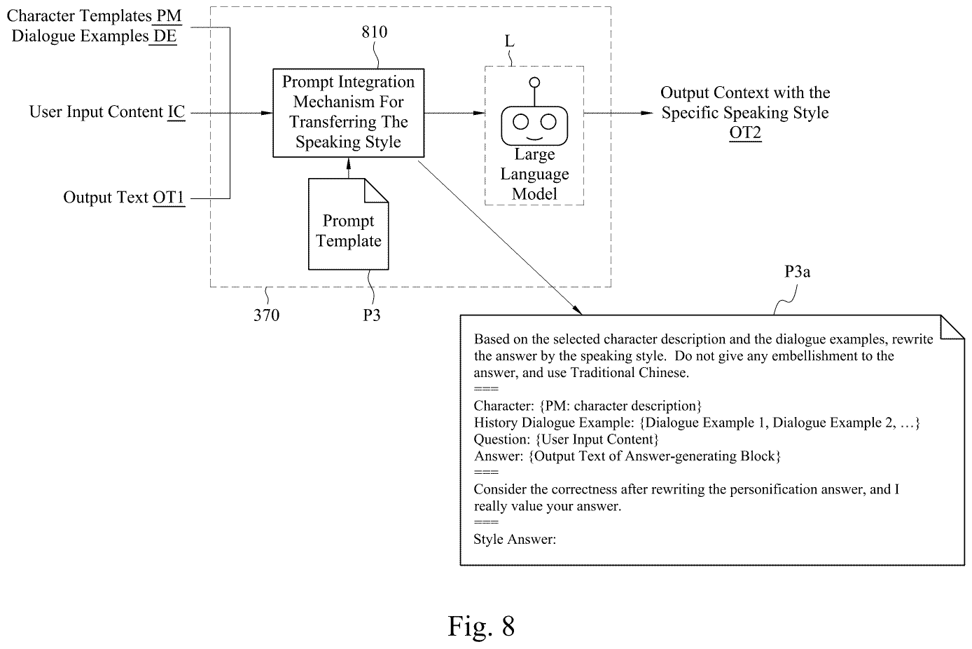

Reference is made incorporating FIG. 8. FIG. 8 is a schematic diagram of operations performed by a style transfer block 370 according to some embodiments of the disclosure. In some embodiments, the style transfer block 370 receives the character templates PM, the dialogue examples DE, the user input content IC, and the output text OT1, performs a prompt integration mechanism 810 for transferring the speaking style to generate the prompt P3a based on the character templates PM, the dialogue examples DE, the user input content IC, the output text OT1, and the prompt template P3, and inputs the prompt P3a to the large language model L to obtain the output text OT2 with some specific speaking style.

Specifically, the prompt integration mechanism 810 for transferring the speaking style determines whether the character templates PM and the dialogue examples outputted by the context awareness block 350 contain content (the determination is made by the threshold of the context awareness block 350), combines the style transfer prompt having the context awareness information with the user input content IC and the output text OT1 of the answer-generating block 330 based on the prompt template P3, and performs the prompt integration with some specific formats. In some embodiments, the style transfer block 370 feeds the character description of the character templates PM to the personal field, feeds the dialogue example (including the dialogue example 1, the dialogue example 2, and so on) corresponding to the input information to the history dialogue field, feeds the user input content IC to the query field of the prompt template P1, and feeds the output text OT1 of the answer-generating block to the answer field, and the prompt P3a is generated.

Then, the large language model L transfers the prompt P3a being integrated to generate the output text OT2 with some specific speaking style.

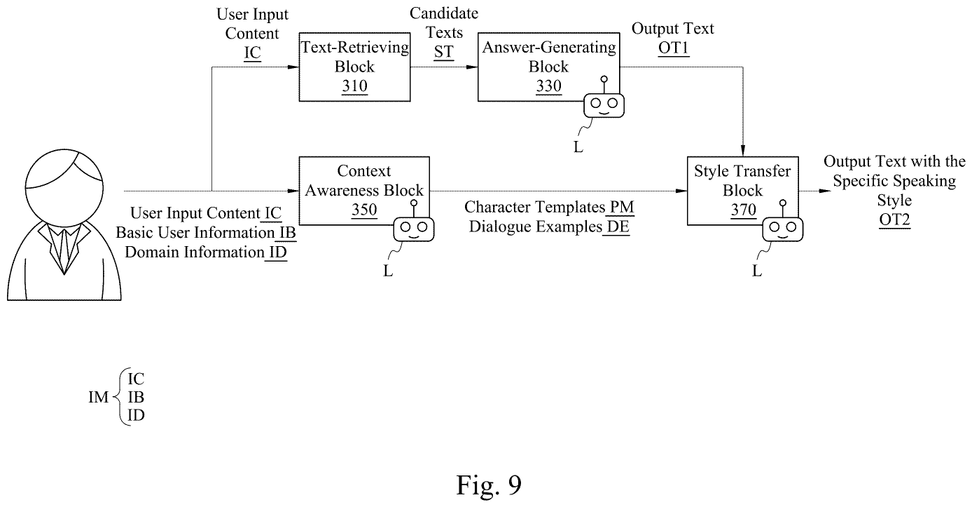

Reference is made to FIG. 9. FIG. 9 is a schematic diagram of coordinate operations performed by the text-retrieving block 310, the answer-generating block 330, the context awareness block 350, and the style transfer block 370 according to some embodiments of the disclosure.

As shown in FIG. 9, the text-retrieving block 310, the answer-generating block 330, the context awareness block 350, and the style transfer block 370 perform incorporation operations by two paths. One path includes operations of the text-retrieving block 310 and the answer-generating block 330, generating the output text OT1 without a specific speaking style. Another path includes operations of the context awareness block 350 and the style transfer block 370, transferring, by the character template, the output text OT1 without a specific speaking style into the output text OT2 with some specific speaking styles.

Specifically, in some embodiments, the text-retrieving block 310 searches suitable candidate texts ST from a database, such as the text knowledge database 154 of FIG. 1 based on the user input content IC of the input information IM and takes the suitable candidate texts ST as the base of generating the answers. Then, the answer-generating block 330 applies some specific prompts and inputs the user input content IC and the candidate texts ST to the large language model to generate the output text OT1 without a specific speaking style. In addition, the context awareness block 350 analyzes the user input content IC of the input information IM, the basic user information IB, and the domain information ID to find the character templates PM and the dialogue examples DE matching the input information IM. Lastly, the style transfer block 370 transfers the output text OT1 without the specific speaking style into the output text OT2 with the specific speaking style based on the character templates PM and the dialogue examples.

For the sake of understanding, the following examples are about the coordination operations of the text-retrieving block 310, the answer-generating block 330, the context awareness block 350, and the style transfer block 370.

In one embodiment, the user input content IC includes “I had a gathering with my high school classmates last week. I think I might have food poisoning related to Wang Pin. Where can I go for a check-up or make an appointment?” The basic user information IB includes “Age: Young adult; Gender: Male; Occupation: Student.” The domain information includes “Public health.”

The text-retrieving block 310 performs the searching based on the user input content IC and outputs the candidate texts ST including the candidate texts 1 to 4. The candidate text 1 includes “Wang Pin food poisoning specialized clinic.”; the candidate text 2 includes “Eye care program for school-age children.”; the candidate text 3 includes “How can I become a health volunteer?”; the candidate text 4 includes “How to prevent food poisoning?”

The answer-generating block 330 feeds the user input content IC to the field, such as the query field of the prompt template P1 shown in FIG. 6, feeds the candidate texts ST (including the candidate texts 1 to 4) to the content field, and performs the prompt integration based on some specific formats to generate the prompt Pla as shown in FIG. 6. The large language model L performs the text generation based on the prompt P1a to generate the output text OT1. The output text OT1 includes “From April 9 to 15, you can schedule an appointment at the Food Safety Special Clinic of Taipei City Hospital Renai Branch, or the Food Safety Special Clinic under the Department of Family Medicine of Taipei City Hospital Zhongxing Branch.”

On the other hand, the context awareness block 350 feeds the user input content IC to the query field of the prompt template P2 of FIG. 7, feeds the domain information to the domain field, feeds the basic user information IB (includes the age, gender, occupation, and so on) to the information field, feeds the multiple character templates (including the character description of No. 0 character template, the character description of No. 1 character template, the character description of No. 2 character template, and so on) of the character database 152 to the personal field to perform the prompt integration based on some specific formats, and the prompt P2a is generated. Based on the prompt P2a, the Personal outputted by the large language model L is the character template PM, the confidence score corresponding to the character template PM computed by the large language model L is 8, and the reason outputted by the large language model L is “Using a motherly perspective with a warm and friendly tone to ensure the student does not feel afraid and is motivated to seek clinic information.”

In some embodiments, because there is no similarity of the history dialogue examples or the candidate dialogue examples smaller than the threshold, the context awareness block 350 outputs an empty dialogue example.

Finally, based on the prompt template P3 shown in FIG. 8, the style transfer block 370 feeds the character description of the character templates PM to the personal field, feeds the dialogue example (because there is no corresponding dialogue example, “no dialogue example” is fed) of the input information to the history dialogue field, feeds the user input content IC to the query field of the prompt template P1, and feeds the output text OT1 outputted by the answer-generating block 330 to the answer field to generate the prompt P3a shown as FIG. 8. Based on the prompt P3a, the large language model L generates a stylized answer, i.e., the output text OT2 with the specific speaking style. The output text OT2 includes “Oh, the recent food poisoning incidents are really scary! From April 9 to 15, we can go to the ‘Food Safety Special Clinic’ of the Taipei City Hospital Renai Branch or the ‘Food Safety Special Clinic under the Department of Family Medicine’ of Taipei City Hospital Zhongxing Branch. Remember to take good care of your health, especially when it comes to food.”

It should be noted that the prompt templates P1 to P3 and the prompts Pla to P3a mentioned above are provided as illustrative examples, system developers may freely modify the prompt templates or prompts based on the usage context and project requirements.

It should be noted that, in some embodiments, the generative question answering system 400 may be implemented as computer programs or commands and stored in the memory 150 of FIG. 1 for the processor 130 of the generative question answering system 100 reading the computer program or commands and performing the operation method. The processor 130 may include one or more chips. The memory 150 may include read-only memory, flash memory, floppy disks, hard disks, optical discs, USB flash drives, magnetic tapes, databases accessible via the network, or any other non-transitory computer-readable storage medium having equivalent functions that those skilled in the art can conceive.

Furthermore, it should be understood that the operations of the generative answering method 400 may be re-ordered and regarded as practical implementation, except those indicated with specific orders, and the operations may be also performed simultaneously or partially simultaneously. In addition, in different embodiments, the operations may be also adaptively added, replaced, and/or omitted.

In some embodiments, the processor 130 of FIG. 1 may be servers, circuits, central processing units (CPU), microprocessors (MCU), or any other circuits, units, or devices with the same functions of storing, computing, data accessing, signals or messages receiving. In addition, the processor of FIG. 1 may include the processor 130A of FIG. 2 or include all the circuits, modules, blocks, or units of the processor 130B of FIG. 3.

In some embodiments, the input-output device 110 of FIG. 1 may be the circuits or units with functions of signal output/input, message output/input, or similar functions.

In some embodiments, all modules, blocks, and units of FIG. 2 and FIG. 3 may be implemented as circuits or units.

According to the implementation of the embodiments mentioned above, the disclosure provides the generative question answering system and the generative question answering. By exploiting the context awareness block, the character templates replace the traditional data-based model training, so training costs can be reduced. Additionally, by exploiting the large language model (LLM) to classify the input information to generate classification results or the character templates matching the input information, the most match dialogue examples corresponding to the character templates of the input information can be obtained. Furthermore, by the text-retrieving block, highly relevant texts are first selected from the text knowledge database, and then the texts are generated by the answer-generating block. Finally, by the style transfer block, based on the character templates and the dialogue examples generated by the context awareness block and the output texts without the specific speaking style generated by the answer-generating block, the style transfer block may generate the output texts with the specific speaking style to generate the customized output answer, and it induces the user to resonate or feel empathized.

In the embodiments, the disclosure provides the incorporative operation by two parallel paths. One path is implemented by the text-retrieving block and the answer-generating block to generate the output text without a specific speaking style. Another path is implemented by the context awareness block and the style transfer block, and the output text without a specific speaking style is transferred to the output text with a specific speaking style. Compared to directly applying a style model to output answers or generate output texts, the disclosure may reduce gibberish and outdated knowledge issues.

Additionally, the above examples include sequential demonstration steps; however, the steps do not have to be executed in the listed order. Executing the steps in a different order is within the scope of the disclosure. Within the spirit and scope of the embodiments of the disclosure, the steps may be added, replaced, reordered, and/or omitted as appropriate. The terms “first” and “second” are used merely to distinguish similar statements and are not intended to impose any order between them or any sequence among the steps involved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. A generative question answering system for generating style texts, comprising:
an input-output device, configured to receive input information;
a memory, configured to store a character database and a text knowledge database, wherein the character database stores multiple character templates comprising multiple character descriptions and multiple dialogue examples corresponding to the multiple character templates, wherein the text knowledge database stores multiple candidate texts; and
a processor, connected to the memory and the input-output device, and configured to perform processes of:
obtaining at least one of the multiple candidate texts from the text knowledge database based on the input information, and generating a first output text by processing the input information and the at least one of the multiple candidate texts using a large language model, wherein the first output text is a natural language response corresponding to the input information;
obtaining, from the character database, a first character template and at least one of the multiple dialogue examples corresponding to the first character template based on the input information; and
generating a second output text by transferring the first output text into a specific speaking style defined by the first character template based on the input information, the first character template, and the at least one of the multiple dialogue examples.

2. The generative question answering system of claim 1, wherein the processor is further configured to perform processes of:
computing multiple similarities between a user input content of the input information and the multiple candidate texts of the text knowledge database; and
obtaining the at least one of the multiple candidate texts based on the multiple similarities.

3. The generative question answering system of claim 1, wherein the processor is further configured to perform processes of:
generating a prompt based on a user input content of the input information and the at least one of the multiple candidate texts; and
inputting the prompt to a large language model to generate the first output text.

4. The generative question answering system of claim 1, wherein the processor is further configured to perform processes of:
generating a prompt based on the input information and the character database; and
inputting the prompt to a large language model to obtain the first character template having highest confidence score.

5. The generative question answering system of claim 4, wherein the input information comprises user input content, basic user information, and domain information.

6. The generative question answering system of claim 4, wherein multiple candidate dialogue examples of the multiple dialogue examples correspond to the first character template, wherein the processor is further configured to perform processes of:
transferring a user input content of the input information into input content vector information;
transferring the multiple candidate dialogue examples into multiple vector information; and
selecting one of the multiple candidate dialogue examples corresponding to a first vector information of the multiple vector information as the at least one of the multiple dialogue examples corresponding to the first character template when a similarity between the first vector information of the multiple vector information and the input content vector information is greater than a threshold.

7. The generative question answering system of claim 1, wherein the processor is further configured to perform processes of:
generating a prompt based on the input information, the first character template, the at least one of the multiple dialogue examples, and the first output text; and
inputting the prompt to a large language model to generate the second output text;
wherein generating the prompt comprises:
accessing a prompt template comprising a personal field, a history dialogue field, a query field, and an answer field; and
feeding the character description of the first character template to the personal field, feeding the at least one of the multiple dialogue example to the history dialogue field, feeding a user input content of the input information to the query field, and feeding the first output text to the answer field.

8. The generative question answering system of claim 1, wherein the text knowledge database comprises the multiple candidate texts, and multiple metadata and multiple vector information of the multiple candidate texts.

9. The generative question answering system of claim 1, wherein the character database further comprises multiple text description information and multiple graphic description information corresponding to the multiple character templates.

10. The generative question answering system of claim 1, wherein the memory further stores a user database, wherein the user database comprises multiple basic user information corresponding to multiple users and multiple domain information.

11. A generative question answering method applied to a generative question answering system comprising a character database and a text knowledge database, wherein the character database stores multiple character templates comprising multiple character descriptions and multiple dialogue examples corresponding to the multiple character templates, wherein the text knowledge database stores multiple candidate texts, wherein the generative question answering method comprises:
obtaining at least one of the multiple candidate texts from the text knowledge database based on input information and generating a first output text by processing the input information and the at least one of the multiple candidate texts using a large language model, wherein the first output text is a natural language response corresponding to the input information;
obtaining, from the character database, a first character template of the multiple character templates and at least one of the multiple dialogue examples corresponding to the first character template based on the input information; and
generating a second output text by transferring the first output text into a specific speaking style defined by the first character template based on the input information, the first character template, and the at least one of the dialogue examples.

12. The generative question answering method of claim 11, further comprising:
computing multiple similarities between a user input content of the input information and the multiple candidate texts of the text knowledge database; and
obtaining the at least one of the multiple candidate texts based on the multiple similarities.

13. The generative question answering method of claim 11, further comprising:
generating a prompt based on a user input content of the input information and the at least one of the multiple candidate texts; and
inputting the prompt to a large language model to generate the first output text.

14. The generative question answering method of claim 11, further comprising:
generating a prompt based on the input information and the character database; and
inputting the prompt to a large language model to obtain the first character template having highest confidence score.

15. The generative question answering method of claim 14, wherein the input information comprises user input content, basic user information, and domain information.

16. The generative question answering method of claim 14, wherein multiple candidate dialogue examples of the multiple dialogue examples correspond to the first character template, wherein the generative question answering method further comprises:
transferring a user input content of the input information into input content vector information;
transferring the multiple candidate dialogue examples into multiple vector information; and
selecting one of the multiple candidate dialogue examples corresponding to a first vector information of the multiple vector information as the at least one of the multiple dialogue examples corresponding to the first character template when a similarity between the first vector information of the multiple vector information and the input content vector information is greater than a threshold.

17. The generative question answering method of claim 11, further comprising:
generating a prompt based on the input information, the first character template, the at least one of the multiple dialogue examples, and the first output text; and
inputting the prompt to a large language model to generate the second output text;
wherein generating the prompt comprises:
accessing a prompt template comprising a personal field, a history dialogue field, a query field, and an answer field; and
feeding the character description of the first character template to the personal field, feeding the at least one of the multiple dialogue example to the history dialogue field, feeding a user input content of the input information to the query field, and feeding the first output text to the answer field.

18. The generative question answering method of claim 11, wherein the text knowledge database comprises the multiple candidate texts, and multiple metadata and multiple vector information of the multiple candidate texts.

19. The generative question answering method of claim 11, wherein the character database further comprises multiple text description information and multiple graphic description information corresponding to the multiple character templates.

20. The generative question answering method of claim 11, further comprising:
storing a user database, wherein the user database comprises multiple basic user information corresponding to multiple users and multiple domain information.
